(19) United States
(12) Patent Application Publication
(10) Pub. No.: US 2022/0032966 A1
(43) Pub. Date: Feb. 3, 2022

(54) ON-VEHICLE CONTROL APPARATUS AND ON-VEHICLE CONTROL SYSTEM

(71) Applicant: MITSUBISHI ELECTRIC CORPORATION, Tokyo (JP)

(72) Inventors: Shuichiro SENDA, Tokyo (JP); Yosuke YOKOYAMA, Tokyo (JP)

(73) Assignee: MITSUBISHI ELECTRIC CORPORATION, Tokyo (JP)

(21) Appl. No.: 17/502,775

(22) Filed: Oct. 15, 2021

Related U.S. Application Data
(63) Continuation of application No. PCT/JP2019/022756, filed on Jun. 7, 2019.

(51) Int. Cl. B60W 60/00; B60W 50/02; B60W 50/029

(52) U.S. Cl. CPC B60W 60/00188; B60W 2050/0095; B60W 50/029; B60W 50/0205

(57) ABSTRACT

An on-vehicle control apparatus (130) switches an operating state of an on-vehicle control system (100) from a regular state to a partially checking state in a case where a cyber-attack has been detected in a part of a plurality of driving control apparatuses (110 and 120). The regular state is an operating state in which autonomous driving is performed by using at least one of the plurality of driving control apparatuses. The partially checking state is an operating state in which the autonomous driving is performed by using at least one of normal driving control apparatuses where the cyber-attack has not been detected, and security of each of the driving control apparatuses where the cyber-attack has been detected is checked.

### CROSS REFERENCE TO RELATED APPLICATIONS

This application is a Continuation of PCT International Application No. PCT/JP2019/022756, filed on Jun. 7, 2019, which is hereby expressly incorporated by reference into the present application.

### TECHNICAL FIELD

The present invention relates to an on-vehicle system for autonomous driving.

### BACKGROUND ART

In order to realize the autonomous driving of a vehicle, it is desired that an on-vehicle control system with high safety is provided.

Patent Literature 1 discloses a vehicle control system.

This vehicle control system includes an autonomous driving integration ECU and an autonomous parking ECU. Then, when the autonomous driving integration ECU malfunctions, the autonomous parking ECU substitutes for a function of the autonomous driving integration ECU. ECU stands for Electronic Control Unit.

### CITATION LIST

### Patent Literature

Patent Literature 1: JP2017-81290A

### SUMMARY OF INVENTION

### Technical Problem

Since the on-vehicle control system is operated by using electronic control, it is important to secure safety against a cyber-attack.

In the vehicle control system disclosed in the Patent Literature 1, the autonomous driving is performed by the autonomous driving integration ECU if the autonomous driving integration ECU does not malfunction. The cyber-attack against the autonomous driving integration ECU is not taken into consideration. Therefore, if the autonomous driving control ECU which does not malfunction is cyber-attacked, there is a possibility that the safety is not secured.

The present invention aims to be able to provide an on-vehicle control system with high safety while taking a cyber-attack into consideration.

### Solution to Problem

An on-vehicle control apparatus according to the present invention is included in an on-vehicle control system that performs autonomous driving of a vehicle.

The on-vehicle control system includes a plurality of driving control apparatuses for the autonomous driving of the vehicle.

The on-vehicle control apparatus includes a regular state unit to switch an operating state of the on-vehicle control system from a regular state to a partially checking state in a case where a cyber-attack has been detected in a part of the plurality of driving control apparatuses.

The regular state is an operating state in which the autonomous driving is performed by using at least one of the plurality of driving control apparatuses.

The partially checking state is an operating state in which the autonomous driving is performed by using at least one of normal driving control apparatuses where the cyber-attack has not been detected, and security of each of the driving control apparatuses where the cyber-attack has been detected is checked.

### Advantageous Effects of Invention

According to the present invention, it is possible to provide an on-vehicle control system with high safety while taking a cyber-attack into consideration.

### BRIEF DESCRIPTION OF DRAWINGS

FIG. 1 is a configuration diagram of an on-vehicle control system 100 according to a first embodiment.

FIG. 2 is a functional configuration diagram of a switching unit of a hub A 130 (on-vehicle control apparatus) according to the first embodiment.

FIG. 3 is a state transition diagram of an on-vehicle control method according to the first embodiment.

FIG. 4 is a flowchart of a regular state (S110) according to the first embodiment.

FIG. 5 is a flowchart of a partially checking state (S120) according to the first embodiment.

FIG. 6 is a flowchart of a partially operating state (S130) according to the first embodiment.

FIG. 7 is a flowchart of a degenerate checking state (S140) according to the first embodiment.

FIG. 8 is a flowchart of an all-checking state (S150) according to the first embodiment.

FIG. 9 is a diagram illustrating a configuration example of the on-vehicle control system 100 according to the first embodiment.

FIG. 10 is a diagram illustrating a configuration example of the on-vehicle control system 100 according to the first embodiment.

FIG. 11 is a hardware configuration diagram of an on-vehicle control apparatus 190 according to the first embodiment.

### DESCRIPTION OF EMBODIMENTS

In the embodiments and the drawings, the same reference numerals are assigned to the same elements or corresponding elements. Descriptions of elements assigned with the same reference numerals as the described elements will be omitted or simplified as appropriate. Arrows in the drawings mainly indicate flows of data or flows of processes.

### First Embodiment

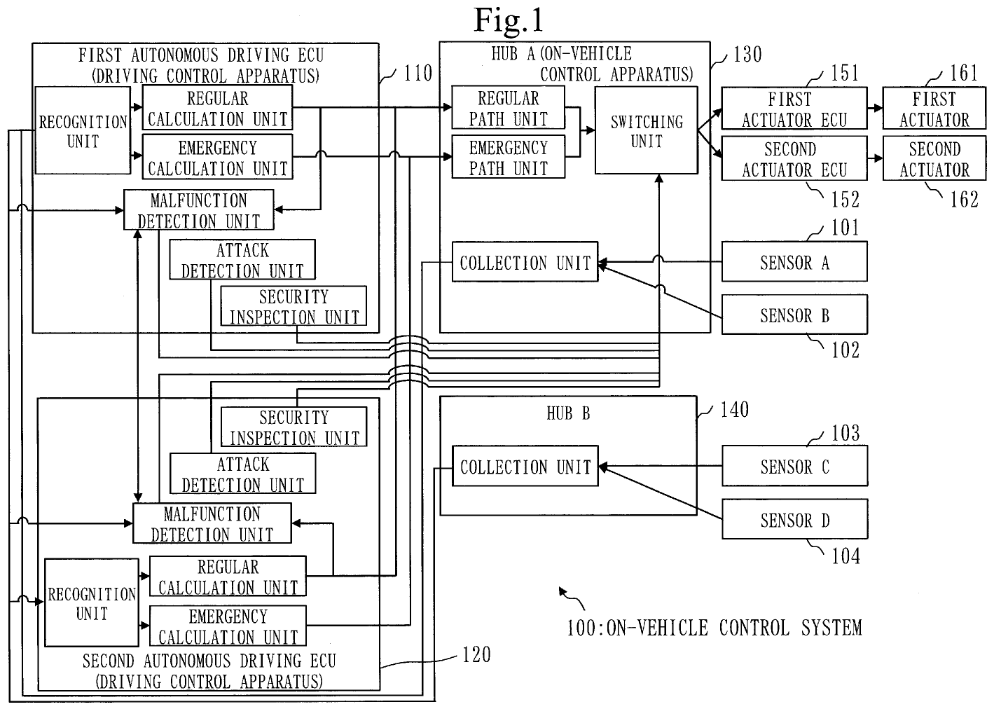

An on-vehicle control system 100 will be described with reference to FIGS. 1 to 11.

***Description of Configuration***

A configuration of the on-vehicle control system 100 will be described with reference to FIG. 1.

The on-vehicle control system 100 is a system installed on a vehicle, and controls autonomous driving of the vehicle.

Specifically, the on-vehicle control system 100 controls a first actuator 161 via a first actuator ECU 151, and controls a second actuator 162 via a second actuator ECU 152.

When neither the first actuator ECU 151 nor the second actuator ECU 152 is specified, each one is referred to as “actuator ECU”.

When neither the first actuator 161 nor the second actuator 162 is specified, each one is referred to as “actuator”.

The actuator is equipment that drives the vehicle. For example, the actuator is a motor, an engine, a brake, or a steering.

The actuator ECU is an apparatus that controls the actuator.

The on-vehicle control system 100 may control one actuator, or control three or more actuators.

The on-vehicle control system 100 includes a first autonomous driving ECU 110 and a second autonomous driving ECU 120.

The first autonomous driving ECU 110 and the second autonomous driving ECU 120 are not influenced by a cyber-attack at the same time due to a measure that the first autonomous driving ECU 110 and the second autonomous driving ECU 120 are realized by different implementations from each other, and so on.

When neither the first autonomous driving ECU 110 nor the second autonomous driving ECU 120 is specified, each one is referred to as “autonomous driving ECU”.

The autonomous driving ECU is an apparatus (driving control apparatus) that outputs driving control information which is for the autonomous driving of the vehicle.

The on-vehicle control system 100 may include three or more autonomous driving ECUs.

The on-vehicle control system 100 includes a hub A 130 and a hub B 140.

A cyber-attack against each of the hub A 130 and the hub B 140 is difficult due to a measure that each of the hub A 130 and the hub B 140 is realized by using a ROM that cannot be rewritten, and so on.

When neither the hub A 130 nor the hub B 140 is specified, each one is referred to as “hub”. The hub is network equipment.

In such a manner that a measure such as falsification detection is taken on a communication cable (communication network) that connects the autonomous driving ECU and the hub to each other, the cyber-attack against the communication network is difficult.

Each hub includes a collection unit. The collection unit is realized by a circuit, software, or a combination of these.

The collection unit of the hub A 130 collects sensor information from a sensor A 101 and a sensor B 102. The collection unit of the hub B 140 collects sensor information from a sensor C 103 and a sensor D 104. When neither the sensor A 101, the sensor B 102, the sensor C 103, nor the sensor D 104 is specified, each one is referred to as “sensor”.

The sensor is equipment that detects a situation around the vehicle. The sensor information is information obtained by the sensor. For example, the sensor is a camera or a laser radar for detecting other vehicles.

Each autonomous driving ECU includes a recognition unit, a regular calculation unit, an emergency calculation unit, a malfunction detection unit, an attack detection unit, and a security inspection unit. These elements are realized by a circuit, software, or a combination of these.

The recognition unit recognizes a situation around the vehicle based on the collected sensor information. A method of recognizing a situation around the vehicle is arbitrary.

The regular calculation unit computes a travelling path (regular path) in regular time based on the recognized situation. A method of computing the regular path is arbitrary. Information (regular path information) indicating the regular path is output as the vehicle control information.

The emergency calculation unit computes a travelling path (emergency path) in emergency time based on the recognized situation. A method of computing the emergency path is arbitrary. Information (emergency path information) indicating the emergency path is output as the vehicle control information.

The malfunction detection unit detects malfunction that has occurred in the autonomous driving ECU. For example, a plurality of regular paths computed by a plurality of autonomous driving ECUs are compared with each other, and the malfunction is detected based on the comparison result. A method of detecting the malfunction is arbitrary.

The attack detection unit detects the cyber-attack that has occurred in the autonomous driving ECU. A method of detecting the cyber-attack is arbitrary.

The security inspection unit tries restoration of a security function in a case where the cyber-attack has been detected, and determines whether or not the security is secured. For example, the security inspection unit restarts the autonomous driving ECU. Then, the security inspection unit determines by using secure boot, whether or not the security function is normal, that is whether or not the security has been secured. A method of checking the security is arbitrary.

The hub A 130 includes a regular path unit and an emergency path unit. Each of the regular path unit and the emergency path unit is realized by a recording medium.

The regular path unit stores the regular path information.

The emergency path unit stores the emergency path information.

The hub A 130 includes a switching unit, and functions as an on-vehicle control apparatus.

The switching unit switches operating states of the on-vehicle control system 100 based on situations of a plurality of driving control apparatuses (110 and 120).

The switching unit is realized by a circuit, software, and a combination of these.

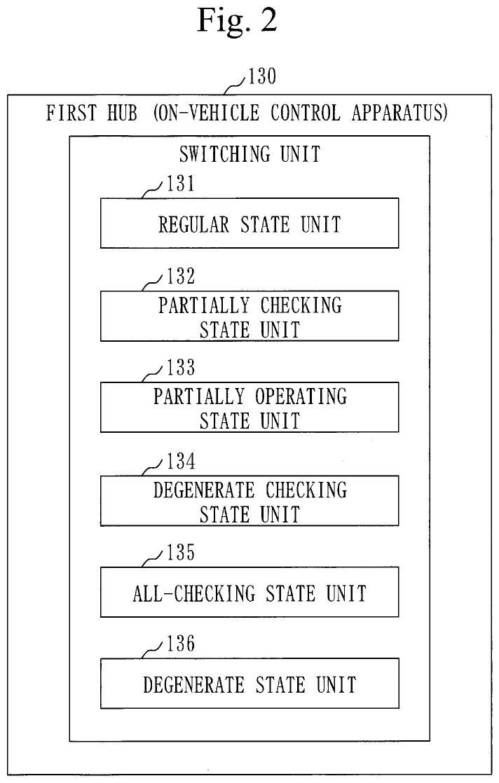

A configuration of the switching unit of the hub A 130 will be described with reference to FIG. 2.

The switching unit of the hub A 130 includes a regular state unit 131, a partially checking state unit 132, a partially operating state unit 133, a degenerate checking state unit 134, an all-checking state unit 135, and a degenerate state unit 136. Functions of these elements will be described later.

***Description of Operation***

A procedure of operation of the on-vehicle control system 100 is equivalent to an on-vehicle control method.

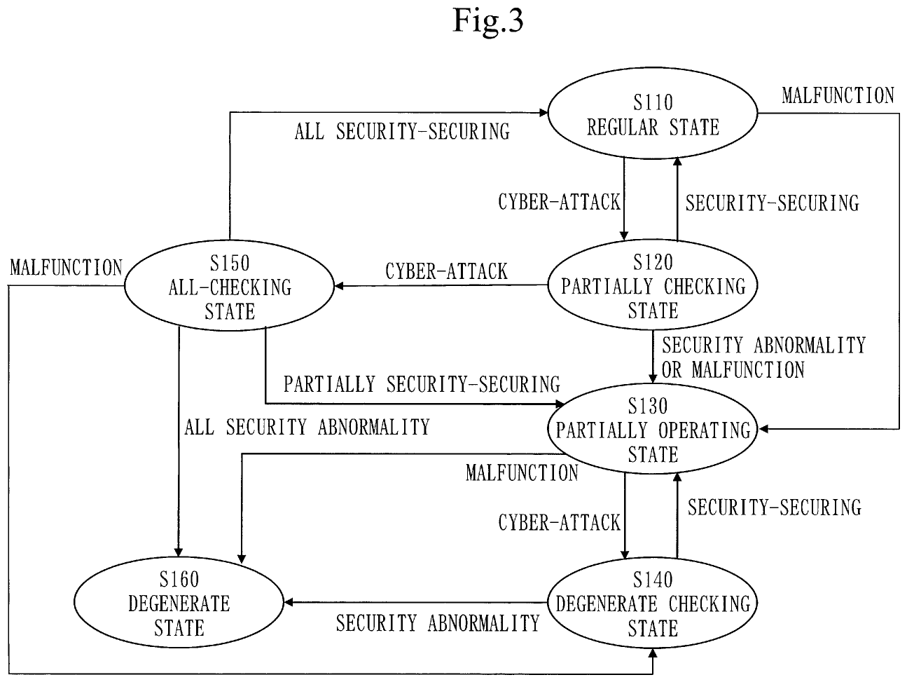

The on-vehicle control method will be described with reference to FIG. 3.

Step S110 is a process performed when the operating state of the on-vehicle control system 100 is a “regular state”, and executed by the regular state unit 131 of the switching unit.

The “regular state” is an operating state adopted when all of the plurality of driving control apparatuses (110 and 120) are normal. The normal driving control apparatus does not malfunction, and the security has been secured.

In step S110, the regular state unit 131 performs the autonomous driving by using at least one of the plurality of driving control apparatuses (110 and 120).

In a case where the cyber-attack has been detected in a part of the plurality of driving control apparatuses, the regular state unit 131 switches the operating state of the on-vehicle control system 100 from the “regular state” to a “partially checking state”.

In a case where the malfunction has been detected in a part of the plurality of driving control apparatuses, the regular state unit 131 switches the operating state of the on-vehicle control system 100 from the “regular state” to a “partially operating state”.

Step S120 is a process adopted when the operating state of the on-vehicle control system 100 is the “partially checking state”, and executed by the partially checking state unit 132 of the switching unit.

The “partially checking state” is an operating state adopted in a case where a part of the plurality of driving control apparatuses (110 and 120) is normal and the cyber-attack has been detected in a part of the plurality of driving control apparatuses.

In step S120, the partially checking state unit 132 performs the autonomous driving by using at least one of the normal driving control apparatuses, and checks the security of each of the driving control apparatuses where the cyber-attack has been detected.

In a case where the security has been secured in all of the driving control apparatuses where the cyber-attack has been detected in the “regular state”, the partially checking state unit 132 switches the operating state of the on-vehicle control system 100 from the “partially checking state” to the “regular state”.

In a case where the security has not been secured in all of the driving control apparatuses where the cyber-attack has been detected in the “regular state”, the partially checking state unit 132 switches the operating state of the on-vehicle control system 100 from the “partially checking state” to the “partially operating state”.

In a case where the cyber-attack has been detected in all of the normal driving control apparatuses in the “partially checking state”, the partially checking state unit 132 switches the operating state of the on-vehicle control system 100 from the “partially checking state” to a “all-checking state”.

In a case where the malfunction has been detected in a part of the normal driving control apparatuses in the “partially checking state”, the partially checking state unit 132 switches the operating state of the on-vehicle control system 100 from the “partially checking state” to the “partially operating state”.

Step S130 is a process adopted when the operating state of the on-vehicle control system 100 is the “partially operating state”, and executed by the partially operating state unit 133.

The “partially operating state” is an operating state adopted when a part of the plurality of driving control apparatuses (110 and 120) is normal and the remaining of the plurality of the driving control apparatuses is abnormal. The abnormal driving control apparatus malfunctions or has security abnormality. The security abnormality is a situation where the security has not been secured although the security has been attempted to be secured.

In step S130, the partially operating state unit 133 performs the autonomous driving by using at least one of the normal driving control apparatuses.

In a case where the cyber-attack has been detected in all of the normal driving control apparatuses in the “partially operating state”, the partially operating state unit 133 switches the operating state of the on-vehicle control system 100 from the “partially operating state” to a “degenerate checking state”.

In a case where the malfunction has been detected in all of the normal driving control apparatuses in the “partially operating state”, the partially operating state unit 133 switches the operating state of the on-vehicle control system 100 from the “partially operating state” to a “degenerate state”.

Step S140 is a process adopted when the operating state of the on-vehicle control system 100 is the “degenerate checking state”, and executed by the degenerate checking state unit 134.

The “degenerate checking state” is an operating state adopted in a case where a part of the plurality of driving control apparatuses (110 and 120) is abnormal and the cyber-attack has been detected in the remaining of the plurality of driving control apparatuses.

In step S140, the degenerate checking state unit 134 performs degenerate operation, and also checks the security of each of the driving control apparatuses where the cyber-attack has been detected in the “partially operating state”.

In a case where the security has been secured in all of the driving control apparatuses where the cyber-attack has been detected in the “partially operating state”, the degenerate checking state unit 134 switches the operating state of the on-vehicle control system 100 from the “degenerate checking state” to the “partially operating state”.

In a case where the security has not been secured in all of the driving control apparatuses where the cyber-attack has been detected in the “partially operating state”, the degenerate checking state unit 134 switches the operating state of the on-vehicle control system 100 from the “degenerate checking state” to the “degenerate state”.

Step S150 is a process adopted when the operating state of the on-vehicle control system 100 is the “all-checking state”, and executed by the all-checking state unit 135.

The “all-checking state” is an operating state adopted in a case where the cyber-attack has been detected in all of the plurality of driving control apparatuses (110 and 120).

In step S150, the all-checking state unit 135 performs degenerate operation, and also checks the security of each of the plurality of driving control apparatuses (110 and 120).

In a case where the security has been secured in all of the plurality of driving control apparatuses, the all-checking state unit 135 switches the operating state of the on-vehicle control system 100 from the “all-checking state” to the “regular state”.

In a case where the security has been secured in a part of the plurality of driving control apparatuses but the security has not been secured in the remaining of the plurality of driving control apparatuses, the all-checking state unit 135 switches the operating state of the on-vehicle control system 100 from the “all-checking state” to the “partially operating state”.

In a case where the security has not been secured in all of the plurality of driving control apparatuses, the all-checking state unit 135 switches the operating state of the on-vehicle control system 100 from the “all-checking state” to the “degenerate state”.

Step S160 is a process adopted when the operating state of the on-vehicle control system 100 is the “degenerate state”, and executed by the degenerate state unit 136.

The “degenerate state” is an operating state adopted when all of the plurality of driving control apparatuses (110 and 120) are abnormal.

In step S160, the degenerate state unit 136 performs the degenerate operation. The degenerate operation is arbitrary operation decided in advance.

Note that, in each of the states from step S110 to step S150, in a case where the malfunction has been detected in all of the driving control apparatuses, or a case where different system abnormality has been detected, the operating state of the on-vehicle control system 100 is switched to the “degenerate state”. For example, when a sensor abnormality occurs, or when a calculation result is not consistent among the autonomous driving ECUs, the system abnormality is detected, and the operating state of the on-vehicle control system 100 is switched to the “degenerate state”.

Specific process procedures in the on-vehicle control method will be described below.

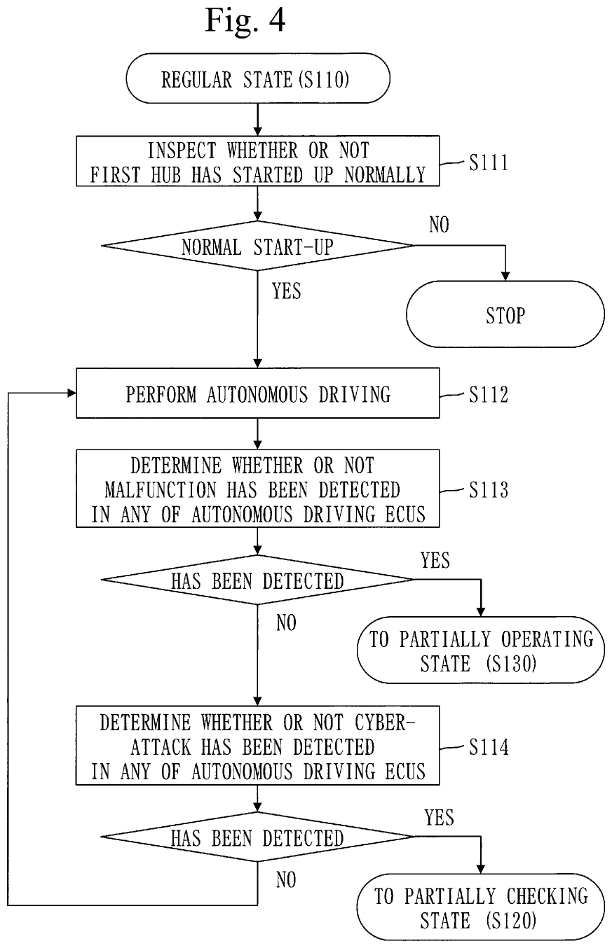

A process procedure of the regular state (S110) will be described with reference to FIG. 4.

It is assumed that both the first autonomous driving ECU 110 and the second autonomous driving ECU 120 are normal.

In step S111, the regular state unit 131 inspects whether or not the hub A 130, that is the on-vehicle control apparatus has started up normally. For example, the regular state unit 131 inspects by using secure boot. An inspection method is arbitrary.

When the hub A 130 (on-vehicle control apparatus) starts up normally, the process proceeds to step S112.

When the hub A 130 (on-vehicle control apparatus) has not started up normally, the autonomous driving function stops, and the process ends.

In step S112, the regular state unit 131 performs the autonomous driving.

For example, the regular state unit 131 controls the actuator by inputting the regular path information of the first autonomous driving ECU 110 into the actuator ECU. As a result, the vehicle travels the regular path.

In step S113, the regular state unit 131 determines whether or not the malfunction has been detected in any of the first autonomous driving ECU 110 and the second autonomous driving ECU 120.

Specifically, when malfunction detection is notified from the malfunction detection unit of the first autonomous driving ECU 110, the regular state unit 131 determines that the malfunction has been detected in the first autonomous driving ECU 110. Further, when the malfunction detection is notified from the malfunction detection unit of the second autonomous driving ECU 120, the regular state unit 131 determines that the malfunction has been detected in the second autonomous driving ECU 120.

In a case where the malfunction has been detected in any of the first autonomous driving ECU 110 and the second autonomous driving ECU 120, the regular state unit 131 calls the partially operating state unit 133. After that, a process of the partially operating state (S130) is executed by the partially operating state unit 133.

In a case where the malfunction has not been detected in any of the first autonomous driving ECU 110 and the second autonomous driving ECU 120, the process proceeds to step S114.

In step S114, the regular state unit 131 determines whether or not the cyber-attack has been detected in any of the first autonomous driving ECU 110 and the second autonomous driving ECU 120.

Specifically, when the attack detection is notified from the attack detection unit of the first autonomous driving ECU 110, the regular state unit 131 determines that the cyber-attack has been detected in the first autonomous driving ECU 110. Further, when the attack detection is notified from the attack detection unit of the second autonomous driving ECU 120, the regular state unit 131 determines that the cyber-attack has been detected in the second autonomous driving ECU 120.

In a case where the cyber-attack has been detected in any of the first autonomous driving ECU 110 and the second autonomous driving ECU 120, the regular state unit 131 calls the partially checking state unit 132. After that, a process of the partially checking state (S120) is executed by the partially checking state unit 132.

In a case where the cyber-attack has not been detected in any of the first autonomous driving ECU 110 and the second autonomous driving ECU 120, the process proceeds to step S112.

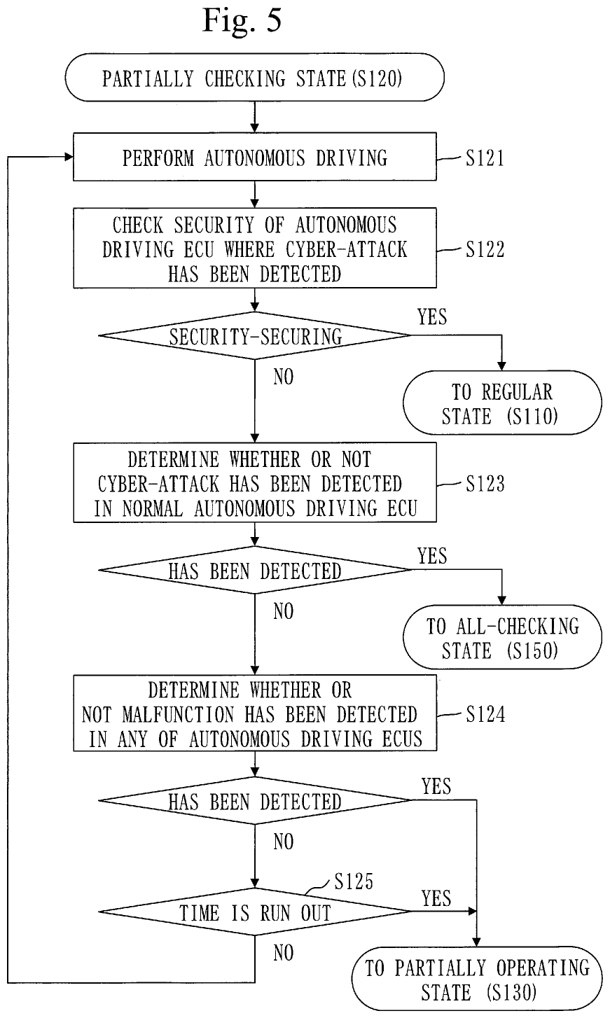

A process procedure of the partially checking state (S120) will be described with reference to FIG. 5.

It is assumed that the first autonomous driving ECU 110 is normal, and the cyber-attack has been detected in the second autonomous driving ECU 120.

In step S121, the partially checking state unit 132 performs the autonomous driving.

Specifically, the partially checking state unit 132 controls the actuator by inputting the regular path information of the first autonomous driving ECU 110 into the actuator ECU. As a result, the vehicle travels the regular path.

In step S122, the partially checking state unit 132 checks the security of the second autonomous driving ECU 120.

Specifically, when security-securing is notified from the security inspection unit of the second autonomous driving ECU 120, the partially checking state unit 132 determines that the security of the second autonomous driving ECU 120 has been secured.

In a case where the security of the second autonomous driving ECU 120 has been secured, the partially checking state unit 132 calls the regular state unit 131. After that, a process of the regular state (S110) is executed by the regular state unit 131.

In a case where the security of the second autonomous driving ECU 120 has not been secured, the process proceeds to step S123.

In step S123, the partially checking state unit 132 determines whether or not the cyber-attack has been detected in the first autonomous driving ECU 110.

Specifically, when the attack detection is notified from the attack detection unit of the first autonomous driving ECU 110, the partially checking state unit 132 determines that the cyber-attack has been detected in the first autonomous driving ECU 110.

In a case where the cyber-attack has been detected in the first autonomous driving ECU 110, the partially checking state unit 132 calls the all-checking state unit 135. After that, a process of the all-checking state (S150) is executed by the all-checking state unit 135.

In step S124, the partially checking state unit 132 determines whether or not the malfunction has been detected in any of the first autonomous driving ECU 110 and the second autonomous driving ECU 120.

Specifically, when the malfunction detection is notified from the malfunction detection unit of the first autonomous driving ECU 110, the partially checking state unit 132 determines that the malfunction has been detected in the first autonomous driving ECU 110. Further, when the malfunction detection is notified from the malfunction detection unit of the second autonomous driving ECU 120, the partially checking state unit 132 determines that the malfunction has been detected in the second autonomous driving ECU 120.

In a case where the malfunction has been detected in any of the first autonomous driving ECU 110 and the second autonomous driving ECU 120, the partially checking state unit 132 calls the partially operating state unit 133. After that, a process of the partially operating state (S130) is executed by the partially operating state unit 133.

In a case where the malfunction has not been detected in any of the first autonomous driving ECU 110 and the second autonomous driving ECU 120, the process proceeds to step S125.

In step S125, the partially checking state unit 132 determines whether or not time of checking the security is run out.

Specifically, the partially checking state unit 132 determines whether or not time which has elapsed since the beginning of the process of the partially checking state (S120) exceeds wait-for-checking time. The wait-for-checking time is time decided in advance as time for checking the security (for example, two seconds).

When the time of checking the security is run out, the partially checking state unit 132 calls the partially operating state unit 133. After that, a process of the partially operating state (S130) is executed by the partially operating state unit 133.

When the time of checking the security is not run out, the process proceeds to step S121.

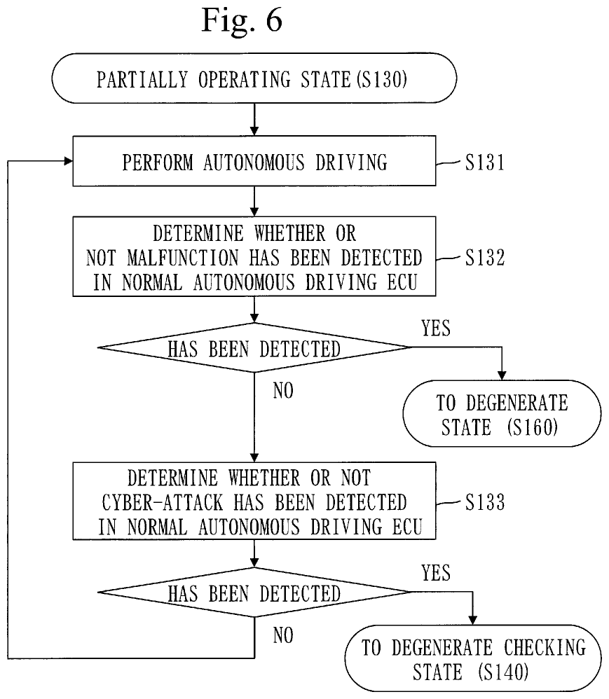

A process procedure of the partially operating state (S130) will be described with reference to FIG. 6.

It is assumed that the first autonomous driving ECU 110 is normal and the second autonomous driving ECU 120 is abnormal.

In step S131, the partially operating state unit 133 performs the autonomous driving.

Specifically, the partially operating state unit 133 controls the actuator by inputting the regular path information of the first autonomous driving ECU 110 into the actuator ECU. As a result, the vehicle travels the regular path.

In step S132, the partially operating state unit 133 determines whether or not the malfunction has been detected in the first autonomous driving ECU 110.

Specifically, when the malfunction detection is notified from the malfunction detection unit of the first autonomous driving ECU 110, the partially operating state unit 133 determines that the malfunction has been detected in the first autonomous driving ECU 110.

In a case where the malfunction has been detected in the first autonomous driving ECU 110, the partially operating state unit 133 calls the degenerate state unit 136. After that, a process of the degenerate state (S160) is executed by the degenerate state unit 136.

In a case where the malfunction has not been detected in the first autonomous driving ECU 110, the process proceeds to step S133.

In step S133, the partially operating state unit 133 determines whether or not the cyber-attack has been detected in the first autonomous driving ECU 110.

Specifically, when the attack detection is notified from the attack detection unit of the first autonomous driving ECU 110, the partially operating state unit 133 determines that the cyber-attack has been detected in the first autonomous driving ECU 110.

In a case where the cyber-attack has been detected in the first autonomous driving ECU 110, the partially operating state unit 133 calls the degenerate checking state unit 134. After that, a process of the degenerate checking state (S140) is executed by the degenerate checking state unit 134.

In a case where the cyber-attack has not been detected in the first autonomous driving ECU 110, the process proceeds to step S131.

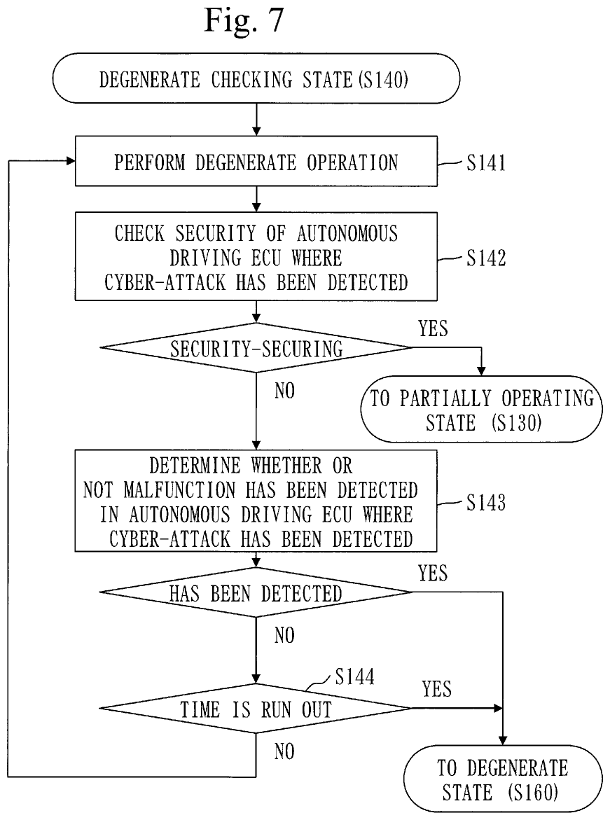

A process procedure of the degenerate checking state (S140) will be described with reference to FIG. 7.

It is assumed that the cyber-attack has been detected in the first autonomous driving ECU 110, and the second autonomous driving ECU 120 malfunctions.

In step S141, the degenerate checking state unit 134 performs the degenerate operation.

Specifically, the degenerate checking state unit 134 controls the actuator by inputting into the actuator ECU, the emergency path information of the first autonomous driving ECU 110. As a result, the vehicle travels the emergency path.

In step S142, the degenerate checking state unit 134 checks the security of the first autonomous driving ECU 110.

Specifically, when the security-securing is notified from the security inspection unit of the first autonomous driving ECU 110, the degenerate checking state unit 134 determines that the security of the first autonomous driving ECU 110 has been secured.

In a case where the security of the first autonomous driving ECU 110 has been secured, the degenerate checking state unit 134 calls the partially operating state unit 133. After that, a process of the partially operating state (S130) is executed by the partially operating state unit 133.

In a case where the security of the first autonomous driving ECU 110 has not been secured, the process proceeds to step S143.

In step S143, the degenerate checking state unit 134 determines whether or not the malfunction has been detected in the first autonomous driving ECU 110.

Specifically, when the malfunction detection is notified from the malfunction detection unit of the first autonomous driving ECU 110, the degenerate checking state unit 134 determines that the malfunction has been detected in the first autonomous driving ECU 110.

In a case where the malfunction has been detected in the first autonomous driving ECU 110, the degenerate checking state unit 134 calls the degenerate state unit 136. After that, a process of the degenerate state (S160) is executed by the degenerate state unit 136.

In a case where the malfunction has not been detected in the first autonomous driving ECU 110, the process proceeds to step S144.

In step S144, the degenerate checking state unit 134 determines whether or not the time of checking the security is run out.

Specifically, the degenerate checking state unit 134 determines whether or not time which has elapsed since the beginning of the process of the degenerate checking state (S140) exceeds wait-for-checking time. The wait-for-checking-time is time decided in advance as time for checking the security (for example, two seconds).

If the time of checking the security is run out, the degenerate checking state unit 134 calls the degenerate state unit 136. After that, the process of the degenerate state (S160) is executed by the degenerate state unit 136.

If the time of checking the security is not run out, the process proceeds to step S141.

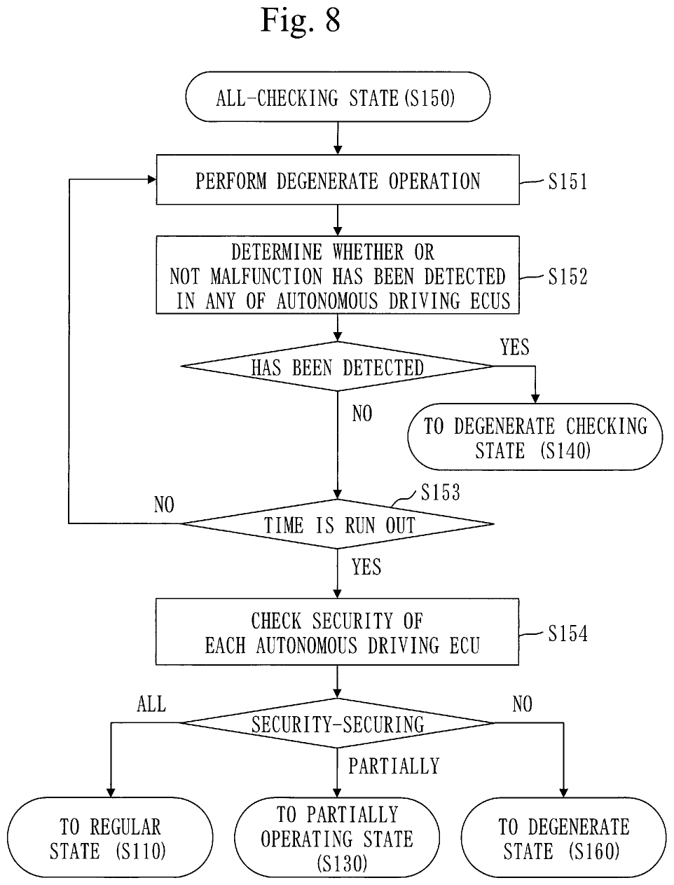

A process procedure of the all-checking state (S150) will be described with reference to FIG. 8.

It is assumed that the cyber-attack has been detected in both the first autonomous driving ECU 110 and the second autonomous driving ECU 120.

In step S151, the all-checking state unit 135 performs the degenerate operation.

Specifically, the all-checking state unit 135 controls the actuator by inputting into the actuator ECU, the emergency path information of the first autonomous driving ECU 110. As a result, the vehicle travels the emergency path.

In step S152, the all-checking state unit 135 determines whether or not the malfunction has been detected in any of the first autonomous driving ECU 110 and the second autonomous driving ECU 120.

Specifically, when the malfunction detection is notified from the malfunction detection unit of the first autonomous driving ECU 110, the all-checking state unit 135 determines that the malfunction has been detected in the first autonomous driving ECU 110. Further, when the malfunction detection is notified from the malfunction detection unit of the second autonomous driving ECU 120, the all-checking state unit 135 determines that the malfunction has been detected in the second autonomous driving ECU 120.

In a case where the malfunction has been detected in any of the first autonomous driving ECU 110 and the second autonomous driving ECU 120, the all-checking state unit 135 calls the degenerate checking state unit 134. After that, the degenerate checking state (S140) is executed by the degenerate checking state unit 134.

In a case where the malfunction has not been detected in both the first autonomous driving ECU 110 and the second autonomous driving ECU 120, the all-checking state unit 135 starts checking the security of each of the first autonomous driving ECU 110 and the second autonomous driving ECU 120, and the process proceeds to step S153.

In step S153, the all-checking state unit 135 determines whether or not the time of checking the security is run out.

Specifically, the all-checking state unit 135 determines whether or not the time which has elapsed since the beginning of the process of the all-checking state (S150) exceeds the wait-for-checking time. The wait-for-checking time is time decided in advance as time of checking the security (For example, two seconds).

When the time of checking the security is run out, the process proceeds to step S154.

When the time of checking the security is not run out, the process proceeds to step S151.

In step S154, the all-checking state unit 135 checks the security of each of the first autonomous driving ECU 110 and the second autonomous driving ECU 120.

Specifically, when the security-securing is notified from the security inspection unit of the first autonomous driving ECU 110, the all-checking state unit 135 determines that the security of the first autonomous driving ECU 110 has been secured. Further, when the security-securing is notified from the security inspection unit of the second autonomous driving ECU 120, the all-checking state unit 135 determines that the security of the second autonomous driving ECU 120 has been secured.

In a case where the security has been secured in both the first autonomous driving ECU 110 and the second autonomous driving ECU 120, the all-checking state unit 135 calls the regular state unit 131. After that, the process of the regular state (S110) is executed by the regular state unit 131.

In a case where the security has been secured in any of the first autonomous driving ECU 110 and the second autonomous driving ECU 120, the all-checking state unit 135 calls the partially operating state unit 133. After that, the process of the partially operating state (S130) is executed by the partially operating state unit 133. In a case where the security has not been secured in any of the first autonomous driving ECU 110 and the second autonomous driving ECU 120, the all-checking state unit 135 calls the degenerate state unit 136. After that, the degenerate state (S160) is executed by the degenerate state unit 136.

A process of the degenerate state (S160) will be described.

The degenerate state unit 136 performs the degenerate operation. Specifically, the degenerate state unit 136 controls the actuator by inputting into the actuator ECU, the emergency path information of the first autonomous driving ECU 110. As a result, the vehicle travels the emergency path.

***Description of Examples***

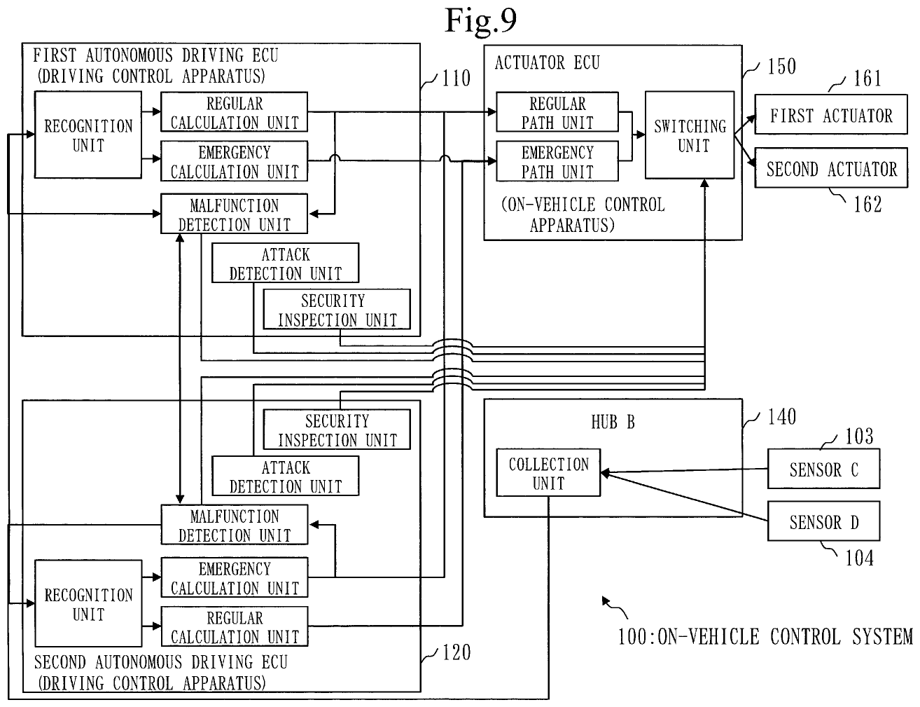

Examples of the on-vehicle control system 100 will be described with reference to FIG. 9.

The on-vehicle control system 100 may include an actuator ECU 150.

The actuator ECU 150 substitutes for the hub A 130, the first actuator ECU 151, and the second actuator ECU 152.

The actuator ECU 150 functions as the on-vehicle control apparatus instead of the hub A 130.

Each autonomous driving ECU may input into the actuator ECU 150, an actuator control signal instead of the driving control information. Further, the switching unit may convert the driving control information into the actuator control signal. The actuator control signal is an actuator-purpose control signal.

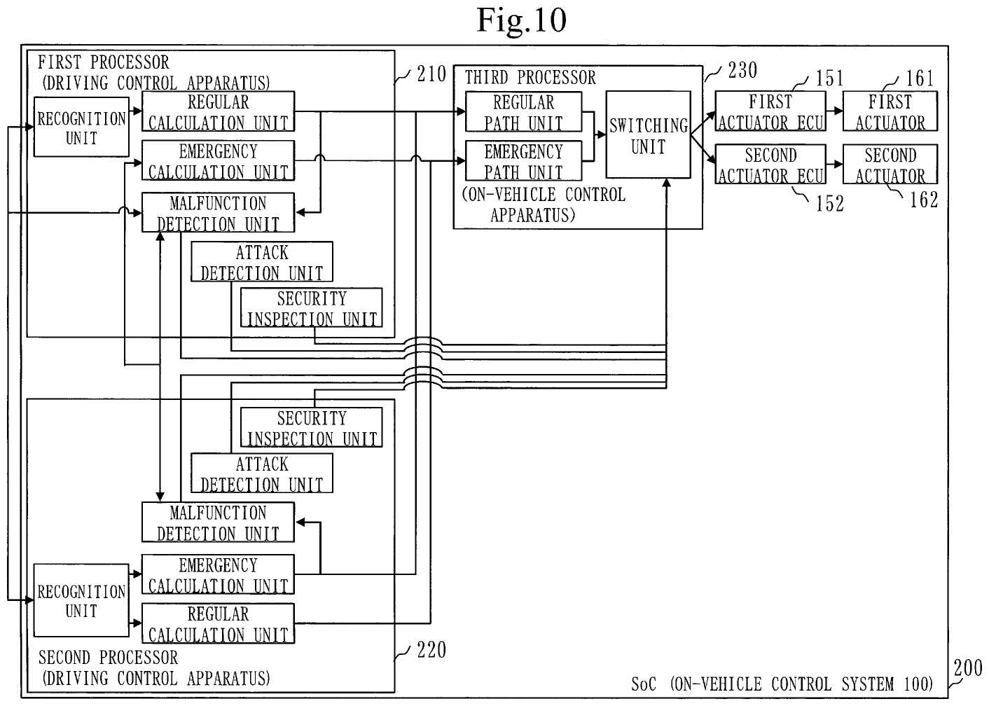

Examples of the on-vehicle control system 100 will be described with reference to FIG. 10. An illustration of the sensor is omitted.

The on-vehicle control system 100 may be realized by an SoC 200. “SoC” stands for System on a Chip.

The SoC 200 includes a first processor 210, a second processor 220, and a third processor 230. Each processor is, for example, a Central Processing Unit (CPU).

The first processor 210 substitutes for the first autonomous driving ECU 110, and the second processor 220 substitutes for the second autonomous driving ECU 120.

Each of the first processor 210 and the second processor 220 functions as the driving control apparatus instead of the autonomous driving ECU.

The third processor 230 functions as the on-vehicle control apparatus instead of the hub A 130.

***Effect of First Embodiment***

According to the first embodiment, it is possible to perform the autonomous driving of the vehicle by using the normal driving control apparatus where the cyber-attack has not been detected. Therefore, it is possible to enhance the safety of the on-vehicle control system 100.

Further, in a case where the security has been secured in the driving control apparatus where the cyber-attack has been detected, it is possible to perform the autonomous driving of the vehicle by using the driving control apparatus. That is, the on-vehicle control system 100 does not shift to the degenerate operation right after being cyber-attacked, and continues an autonomous driving operation. Therefore, it is possible to extend time during which the autonomous driving can be continued, and decrease maintenance frequency. Further, it is possible to enhance availability of the on-vehicle control system 100.

***Supplement to First Embodiment***

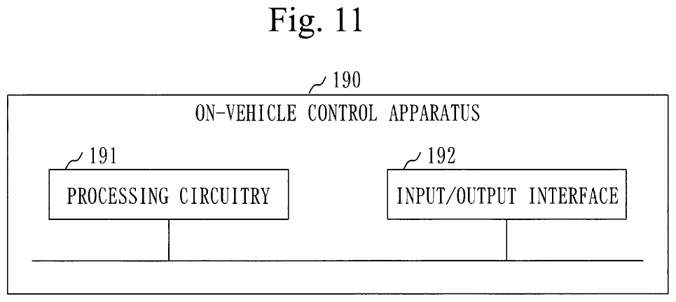

A hardware configuration of an on-vehicle control apparatus 190 will be described with reference to FIG. 11.

The on-vehicle control apparatus 190 is an on-vehicle control apparatus included in the on-vehicle control system 100.

The on-vehicle control apparatus 190 includes a processing circuitry 191 and an input/output interface 192.

The processing circuitry 191 is hardware that realizes the switching unit, the regular path unit, and the emergency path unit.

The processing circuitry 191 may be a dedicated hardware, or may be a processor that executes a program stored in a memory.

When the processing circuitry 191 is the dedicated hardware, the processing circuitry 191 is, for example, a single circuit, a composite circuit, a programmed-processor, a parallel-programmed processor, an ASIC, an FPGA, or a combination of these.

ASIC stands for Application Specific Integrated Circuit.

FPGA stands for Field Programmable Gate Array.

The on-vehicle control apparatus 190 may include a plurality of processing circuitries that substitute for the processing circuitry 191. The plurality of processing circuitries share a roll of the processing circuitry 191.

The input/output interface 192 is a port for inputting and outputting the driving control information or the like.

In the on-vehicle control apparatus 190, a part of functions may be realized by the dedicated hardware, and the remaining functions may be realized by software or firmware.

As described above, the processing circuitry 191 can be realized by hardware, software, firmware, or a combination of these.

The embodiments are examples of preferred modes, and are not intended to limit the technical scope of the present invention. The embodiments may be implemented partially or may be implemented being combined with other modes. The procedures described using the flowcharts and the like may be changed as appropriate.

“Unit” which is an element of the on-vehicle control system 100 may be read as “process” or “step”.

### REFERENCE SIGNS LIST

100: on-vehicle control system, 101: sensor A, 102: sensor B, 103: sensor C, 104: sensor D, 110: first autonomous driving ECU, 120: second autonomous driving ECU, 130: hub A, 131: regular state unit, 132: partially checking state unit, 133: partially operating state unit, 134: degenerate checking state unit, 135: all-checking state unit, 136: degenerate state unit, 140: hub B, 150: actuator ECU, 151: first actuator ECU, 152: second actuator ECU, 161: first actuator, 162: second actuator, 190: on-vehicle control apparatus, 191: processing circuitry, 192: input/output interface, 200: SoC, 210: first processor, 220: second processor, 230: third processor.

1. An on-vehicle control apparatus comprised in an on-vehicle control system that performs autonomous driving of a vehicle,
wherein the on-vehicle control system comprises a plurality of driving control apparatuses for the autonomous driving of the vehicle,
wherein the on-vehicle control apparatus comprises:
processing circuitry
to switch an operating state of the on-vehicle control system from a regular state to a partially checking state in a case where a cyber-attack has been detected in a part of the plurality of driving control apparatuses; and
to switch the operating state of the on-vehicle control system from the partially checking state to the regular state in a case where security has been secured in all of the driving control apparatuses where the cyber-attack has been detected in the regular state, and switch the operating state of the on-vehicle control system from the partially checking state to a partially operating state in a case where the security has not been secured in all of the driving control apparatuses where the cyber-attack has been detected in the regular state,
wherein the regular state is an operating state in which the autonomous driving is performed by using at least one of the plurality of driving control apparatuses,
wherein the partially checking state is an operating state in which the autonomous driving is performed by using at least one of normal driving control apparatuses where the cyber-attack has not been detected, and the security of each of the driving control apparatuses where the cyber-attack has been detected is checked, and
wherein the partially operating state is an operating state in which the autonomous driving is performed by using at least one of the normal driving control apparatuses.

2. The on-vehicle control apparatus according to claim 1,
wherein the processing circuitry switches the operating state of the on-vehicle control system from the partially operating state to a degenerate checking state in a case where the cyber-attack has been detected in all of the normal driving control apparatuses in the partially operating state, and
wherein the degenerate checking state is an operating state in which degenerate operation is performed and the security of each of the driving control apparatuses where the cyber-attack has been detected in the partially operating state is checked.

3. The on-vehicle control apparatus according to claim 2,
wherein the processing circuitry switches the operating state of the on-vehicle control system from the degenerate checking state to the partially operating state in a case where the security has been secured in at least one of the driving control apparatuses where the cyber-attack has been detected in the partially operating state.

4. The on-vehicle control apparatus according to claim 3,
wherein the processing circuitry switches the operating state of the on-vehicle control system from the degenerate checking state to a degenerate state in a case where the security has not been secured in all of the driving control apparatuses where the cyber-attack has been detected in the partially operating state, and
wherein the degenerate state is an operating state in which the degenerate operation is performed.

5. An on-vehicle control apparatus comprised in an on-vehicle control system that performs autonomous driving of a vehicle,
wherein the on-vehicle control system comprises a plurality of driving control apparatuses for the autonomous driving of the vehicle,
wherein the on-vehicle control apparatus comprises:
processing circuitry
to switch an operating state of the on-vehicle control system from a regular state to a partially checking state in a case where a cyber-attack has been detected in a part of the plurality of driving control apparatuses;
to switch the operating state of the on-vehicle control system from the partially checking state to the regular state in a case where security has been secured in all of the driving control apparatuses where the cyber-attack has been detected in the regular state, and switch the operating state of the on-vehicle control system from the partially checking state to an all-checking state in a case where the cyber-attack has been detected in all of normal driving control apparatuses where the cyber-attack has not been detected in the partially checking state; and
to switch the operating state of the on-vehicle control system from the all-checking state to the regular state in a case where the security has been secured in all of the plurality of driving control apparatuses, and switch the operating state of the on-vehicle control system from the all-checking state to a degenerate state in a case where the security has not been secured in all of the plurality of driving control apparatuses,
wherein the regular state is an operating state in which the autonomous driving is performed by using at least one of the plurality of driving control apparatuses,
wherein the partially checking state is an operating state in which the autonomous driving is performed by using at least one of the normal driving control apparatuses, and the security of each of the driving control apparatuses where the cyber-attack has been detected is checked,
wherein the all-checking state is an operating state in which degenerate operation is performed and the security of each of the plurality of driving control apparatuses is checked, and
wherein the degenerate state is an operating state in which the degenerate operation is performed.

6. An on-vehicle control apparatus comprised in an on-vehicle control system that performs autonomous driving of a vehicle,
wherein the on-vehicle control system comprises a plurality of driving control apparatuses for the autonomous driving of the vehicle,
wherein the on-vehicle control apparatus comprises:
processing circuitry
to switch an operating state of the on-vehicle control system from a regular state to a partially checking state in a case where a cyber-attack has been detected in a part of the plurality of driving control apparatuses;
to switch the operating state of the on-vehicle control system from the partially checking state to the regular state in a case where security has been secured in all of the driving control apparatuses where the cyber-attack has been detected in the regular state, and switch the operating state of the on-vehicle control system from the partially checking state to an all-checking state in a case where the cyber-attack has been detected in all of normal driving control apparatuses where the cyber-attack has not been detected in the partially checking state; and
to switch the operating state of the on-vehicle control system from the all-checking state to the regular state in a case where the security has been secured in all of the plurality of driving control apparatuses, and switch the operating state of the on-vehicle control system from the all-checking state to a partially operating state in a case where the security has been secured in at least one of the plurality of driving control apparatuses,
wherein the regular state is an operating state in which the autonomous driving is performed by using at least one of the plurality of driving control apparatuses,
wherein the partially checking state is an operating state in which the autonomous driving is performed by using at least one of the normal driving control apparatuses, and the security of each of the driving control apparatuses where the cyber-attack has been detected is checked,
wherein the all-checking state is an operating state in which degenerate operation is performed and the security of each of the plurality of driving control apparatuses is checked, and
wherein the partially operating state is an operating state in which the autonomous driving is performed by using at least one of the driving control apparatuses where the security has been secured in the all-checking state.

7. The on-vehicle control apparatus according to claim 6,
wherein the processing circuitry switches the operating state of the on-vehicle control system from the partially operating state to a degenerate checking state in a case where the cyber-attack has been detected in all of the driving control apparatuses where the security has been secured in the all-checking state, and
wherein the degenerate checking state is an operating state in which the degenerate operation is performed and the security of each of the driving control apparatuses where the cyber-attack has been detected in the partially operating state is checked.

8. The on-vehicle control apparatus according to claim 7,
wherein the processing circuitry switches the operating state of the on-vehicle control system from the degenerate checking state to the partially operating state in a case where the security has been secured in all of the driving control apparatuses where the cyber-attack has been detected in the partially operating state.

9. The on-vehicle control apparatus according to claim 8,
wherein the processing circuitry switches the operating state of the on-vehicle control system from the degenerate checking state to a degenerate state in a case where the security has not been secured in all of the driving control apparatuses where the cyber-attack has been detected in the partially operating state, and
wherein the degenerate state is an operating state in which the degenerate operation is performed.

10. An on-vehicle control system comprising:
the on-vehicle control apparatus according to claim 1; and
a plurality of driving control apparatuses for autonomous driving of a vehicle.

11. An on-vehicle control system comprising:
the on-vehicle control apparatus according to claim 2; and
a plurality of driving control apparatuses for autonomous driving of a vehicle.

12. An on-vehicle control system comprising:
the on-vehicle control apparatus according to claim 3; and
a plurality of driving control apparatuses for autonomous driving of a vehicle.

13. An on-vehicle control system comprising:
the on-vehicle control apparatus according to of claim 4; and
a plurality of driving control apparatuses for autonomous driving of a vehicle.

14. An on-vehicle control system comprising:
the on-vehicle control apparatus according to claim 5; and
a plurality of driving control apparatuses for autonomous driving of a vehicle.

15. An on-vehicle control system comprising:
the on-vehicle control apparatus according to claim 6; and
a plurality of driving control apparatuses for autonomous driving of a vehicle.

16. An on-vehicle control system comprising:
the on-vehicle control apparatus according to claim 7; and
a plurality of driving control apparatuses for autonomous driving of a vehicle.

17. An on-vehicle control system comprising:
the on-vehicle control apparatus according to claim 8; and
a plurality of driving control apparatuses for autonomous driving of a vehicle.

18. An on-vehicle control system comprising:
the on-vehicle control apparatus according to claim 9; and
a plurality of driving control apparatuses for autonomous driving of a vehicle.
